(19) United States
(12) Patent Application Publication
(10) Pub. No.: US 2014/0074549 A1
(43) Pub. Date: Mar. 13, 2014

(54) System and Method for Providing a Comparative Assessment of Potential Vendors

(71) Applicants: Ashu Chugh, Haryana (IN); Vivek Singh, Delhi (IN); Robin Malik, Haryana (IN); Prasurya Borah, Haryana (IN)

(72) Inventors: Ashu Chugh, Haryana (IN); Vivek Singh, Delhi (IN); Robin Malik, Haryana (IN); Prasurya Borah, Haryana (IN)

(73) Assignee: Bank of America Corporation, Charlotte, NC (US)

(21) Appl. No.: 13/607,915

(22) Filed: Sep. 10, 2012

(51) Int. Cl. G06Q 30/02

(52) U.S. Cl. 705/7.29

(57) ABSTRACT

In certain embodiments, a method includes accessing, for each of a plurality of potential vendors, vendor data corresponding to one or more operational efficiency criteria and vendor data corresponding one or more market viability criteria. The method further includes determining, for each of a plurality of potential vendors, (1) an operational efficiency score accounting for criteria-specific scores determined based on the accessed vendor data for each of the one or more operational efficiency criteria, and (2) a market viability score accounting for criteria-specific scores determined based on the accessed vendor data for each of the one or more market viability criteria. The method further includes generating a graphical display depicting each of the plurality of potential vendors, wherein each of the plurality of vendors is positioned relative to a first axis according to the determined operational efficiency score and a second axis according to the determined market viability score.

### TECHNICAL FIELD OF THE INVENTION

This disclosure relates generally to vendor selection and more particularly to a system and method for providing a comparative assessment of potential vendors.

### BACKGROUND OF THE INVENTION

In certain industries, enterprises may have purchasing departments charged with procuring goods and services for the enterprise. As part of the procurement process, purchasing departments may evaluate the various potential vendors from which the enterprise may purchase goods or services. Because of the possibly large number of potential vendors and the diverse set criteria that may be important to the enterprise, the process of assessing potential vendors is often complex and time consuming.

### SUMMARY OF THE INVENTION

According to embodiments of the present disclosure, disadvantages and problems associated with previous techniques for assessing potential vendors may be reduced or eliminated.

In certain embodiments, a method includes accessing, for each of a plurality of potential vendors, vendor data corresponding to one or more operational efficiency criteria and vendor data corresponding one or more market viability criteria. The method further includes determining, for each of a plurality of potential vendors, (1) an operational efficiency score accounting for criteria-specific scores determined based on the accessed vendor data for each of the one or more operational efficiency criteria, and (2) a market viability score accounting for criteria-specific scores determined based on the accessed vendor data for each of the one or more market viability criteria. The method further includes generating a graphical display depicting each of the plurality of potential vendors, wherein each of the plurality of vendors is positioned relative to a first axis according to the determined operational efficiency score and a second axis according to the determined market viability score.

Particular embodiments of the present disclosure may provide one or more technical advantages. For example, in certain embodiments, the present disclosure may provide a single graphical depiction representing a comparison of multiple vendors based on a number of different criteria. Accordingly, certain embodiments of the present disclosure may provide for increased efficiency in vendor assessment.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

FIG. 1 illustrates an example system for providing a comparative assessment of potential vendors for an enterprise, according to certain embodiments of the present disclosure;

FIG. 2 illustrates an example graphical display constituting an industry level comparison of a number of potential computer hardware vendors, according to certain embodiments of the present disclosure;

FIG. 3 illustrates an example graphical display constituting an product/service level comparison specific to desktop computers for a number of potential computer hardware vendors, according to certain embodiments of the present disclosure; and

FIG. 4 illustrates an example method for providing a comparative assessment of potential vendors for an enterprise, according to certain embodiments of the present disclosure.

### DETAILED DESCRIPTION OF THE INVENTION

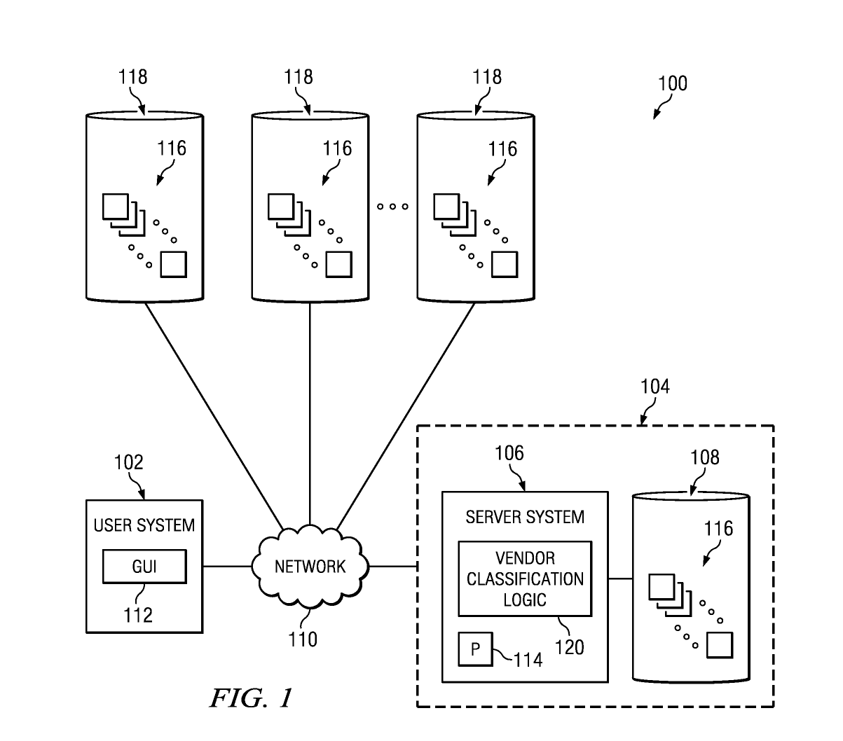

FIG. 1 illustrates an example system 100 for providing a comparative assessment of potential vendors for an enterprise, according to certain embodiments of the present disclosure. System 100 may include a user system 102 and an vendor classification system 104. Vendor classification system 104 may include a server system 106 and a database 108. User system 102 may be configured to communicate with vendor classification system 104 via a network 110. Although this particular implementation of system 100 is illustrated and primarily described, the present invention contemplates any suitable implementation of system 100 according to particular needs.

In general, system 100 is operable to generate a comparative assessment of a number of potential vendors to an enterprise. The comparative assessment may be based on vendor data 116 for each of the potential vendors, which may be gathered from internal sources (e.g., database 108) and/or external sources (publicly-available data sources 118). The gathered vendor data 116 may be used to determine an operational efficiency score for each of the vendors. In certain embodiments, the operational efficiency score for a vendor may be representative of financial strength criteria for the vendor (e.g., profitability, growth, liquidity, efficiency) and employee criteria for the vendor (e.g., revenue per employee, net profit per employee). The gathered vendor data 116 may additionally be used to determine a market viability score for each of the vendors. In certain embodiments, the market viability score for a vendor may be representative of geographic presence criteria for the vendor (e.g., global presence of the vendor, regional presence of the vendor), mergers and acquisitions criteria (e.g., the number of acquisitions by the vendor, the total value of those acquisitions, whether new services have been added, relationships between the acquiree and the enterprise) and litigation criteria (e.g., existence of patent related litigations and contract related litigations). Each of the potential vendors may then be depicted on a graphical display according to the determined operational efficiency and market viability scores, providing an industry level comparative assessment of each of the potential vendors.

User system 102 may include any suitable device or combination of devices operable to allow a user (e.g., an enterprise employee or other authorized personnel) to access all or a portion of the functionality associated with vendor classification system 104 (as described in detail below). For example, user system 102 may include one or more computer systems at one or more locations. A computer system, as used herein, may include a personal computer, workstation, network computer, kiosk, wireless data port, personal data assistant (PDA), one or more processors within these or other devices, or any other suitable processing device. Additionally, each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media.

In certain embodiments, user system 102 may include a graphical user interface (GUI) 112, which may be delivered using an online portal, hypertext mark-up language (HTML) pages for display and data capture, or in any other suitable manner. GUI 112 may allow a user of user system 102 to interact with other components of system 100. For example, GUI 112 may allow a user of user system 102 to access all or a portion of the functionality associated with vendor classification system 104 (as described in further detail below). Although a single user system 102 is depicted and described, the present disclosure contemplates that system 100 may include any suitable number of user systems 102, according to particular needs.

Although a single user system is depicted for purposes of simplicity, the present disclosure contemplates that system 100 may include any suitable number of user systems, according to particular needs.

User system 102 may be communicatively coupled to vendor classification system 104 via network 110. Network 110 may facilitate wireless or wireline communication and may communicate, for example, IP packets, Frame Relay frames, Asynchronous Transfer Mode (ATM) cells, voice, video, data, and other suitable information between network addresses. Network 110 may include one or more local area networks (LANs), radio access networks (RANs), metropolitan area networks (MANs), wide area networks (WANs), all or a portion of the global computer network known as the Internet, and/or any other communication system or systems at one or more locations.

Vendor classification system 104 may include any suitable system operable to generate a comparative assessment of a number of potential vendors for an enterprise based on vendor data 116 (as described in further detail below). In certain embodiments, vendor classification system 104 may include a server system 106 and a database 108. Server system 106 may include one or more electronic computing devices operable to receive, transmit, process, and store data associated with system 100. For example, server system 106 may include one or more general-purpose PCs, Macintoshes, workstations, Unix-based computers, server computers, one or more server pools, or any other suitable devices. In short, server system 106 may include any suitable combination of software, firmware, and hardware. Although a single server system 106 is illustrated, the present disclosure contemplates system 100 including any suitable number of server systems 106. Moreover, although referred to as a “server system,” the present disclosure contemplates server system 106 comprising any suitable type of processing device or devices.

Server system 106 may include one or more processing modules 114, each of which may include one or more microprocessors, controllers, or any other suitable computing devices or resources. Processing modules 114 may work, either alone or with other components of system 100, to provide a portion or all of the functionality of system 100 described herein. Server system 106 may additionally include (or be communicatively coupled to) a database 108. Database 108 may comprise any suitable memory module and may take the form of volatile or non-volatile memory, including, without limitation, magnetic media, optical media, random access memory (RAM), read-only memory (ROM), removable media, or any other suitable local or remote memory component.

In certain embodiments, database 108 may store vendor data 116 for one or more potential vendors of the enterprise. Vendor data 116 may include any suitable information generated and/or gathered by the enterprise that is representative of the business of a potential vendor. For example, vendor data 116 may include information regarding vendor financials (e.g., profitability, growth, liquidity, efficiency, etc.), vendor employees (e.g., the number of employees, revenue per employee, profit per employee, etc.), vendor geographic presence (e.g., global presence, regional presence, etc.), vendor activity in mergers and acquisitions (e.g., number of vendor acquisitions, total value of those acquisitions, etc), and vendor litigation activity (e.g., the number of patent and contract related disputes in which the vendor is involved). To the extent that one or more potential vendors are also current/past vendors for the enterprise, vendor data 116 may additionally include historical spending data for those vendors (e.g., the growth percentage of enterprise spending with the vendor, twelve month rolling spending by the enterprise with the vendor, the percentage of vendor revenue derived from enterprise spending, etc.).

In certain embodiments, vendor data 116 stored on database 108 may be manually generated by one or more enterprise employees. For example, vendor data 116 regarding vendor financials may be manually created by an enterprise employee based on a review of relevant information (e.g., Securities and Exchange Commission (SEC) filings, news articles, etc.). Additionally or alternatively, vendor data 116 stored on database 108 may be automatically generated using any suitable application operable to gather relevant information. For example, a web crawler application may be operable to generated vendor data 116 based on one or more websites containing relevant information (e.g., financial information for certain potential vendors may be gathered from the SEC website, news articles, or any other suitable location). Although particular vendor data 116 has been described as being generated in a particular manner, the present disclosure contemplates any suitable vendor data being generated in any suitable manner, according to particular needs.

In certain embodiments, certain vendor data 116 may not be stored on vendor classification system 104. Rather, the vendor data 116 may be accessed by vendor classification system 104 from one or more publicly-available data sources 118 with which vendor classification system 104 is configured to communicate (e.g., via network 110). As just one example, information regarding vendor financials (e.g., profitability, growth, liquidity, efficiency, etc.) may not be stored locally on database 108 but may be accessed from a publicly available data source 118. Example publicly available data source 118 may include a SEC database (e.g., accessible via the Internet), repositories storing news article concerning the vendor, or any other suitable location.

In certain embodiments, server system 110 may include vendor classification logic 120. Vendor classification logic 120 may include any suitable combination of hardware, firmware, and software operable to generate a comparative assessment for a number of potential vendors for an enterprise based on accessed vendor data 116, as described in detail below. As just one example, vendor classification logic 120 may be based on a Microsoft Excel based model.

In certain embodiments, vendor classification logic 120 may generate a graphical display representing an industry level comparison of a number of potential vendors. For example, a user of user system 102 may be charged with assessing the different vendors who may provide the enterprise with a certain product. In order to evaluate the potential vendors, the user of user system 102 may communicate a request for an industry level comparative analysis to vendor classification logic 120. The request may include an identification of the potential vendors to be assessed and a specification of the operational efficiency criteria and market viability criteria on which the potential vendors should be assessed. The user may additionally allocate a weighting for each of the specified criteria. In certain embodiment, vendor classification logic 120 may be configured to assess identified potential vendors based on a pre-determined set of equally-weighted operational efficiency criteria and market viability criteria, and the user may be able to deselect certain of the pre-determined criteria and/or change the weighting allocated to certain criteria.

In response to the user request, vendor classification logic 120 may access relevant vendor data 116 (e.g., from database 108 and/or publicly-available data sources 118). The relevant vendor data 116 may include data corresponding to each of the operational efficiency criteria and market viability criteria specified by the user. Based on the accessed vendor data 116, vendor classification logic 120 may determine, for each potential vendor, a criteria-specific score for each of the criteria specified by the user for each identified potential vendor. In certain embodiments, the criteria-specific score for a particular vendor may comprise a relative ranking of that vendor relative to all other vendors assessed (e.g., the criteria-specific score be a value from 1 to n, where n is the total number of potential vendors being assessed).

Having determined a criteria-specific score for each of the specified operational efficiency criteria, vendor classification logic 120 may determine an operational efficiency score for each potential vendor based on the criteria-specific scores for each of the operational efficiency criteria. For example, vendor classification logic 120 may sum the criteria-specific scores for each of the operational efficiency criteria, accounting for any weighting specified by the user. Similarly, vendor classification logic 120 may determine an market viability score for each potential vendor based on the criteria-specific scores for each of the specified market viability criteria. For example, vendor classification logic 120 may sum the criteria-specific scores for each of the market viability criteria, accounting for any weighting specified by the user.

Vendor classification logic 120 may be additionally operable to generate, based on the determined operational efficiency scores and market viability scores, a graphical display representing an industry level comparison of all identified potential vendors. The graphical display may be delivered to the user via GUI 112. For example, each of the identified potential vendors may be placed positioned along an x-axis according to their operational efficiency score and along a y-axis according to their market viability score. Additionally, the x-axis may be located on the graphical display at a position representative of the average operational efficiency score of all indentified potential vendors. Similarly, the y-axis may be located on the graphical display at a position representative of the average market viability score of all indentified potential vendors. As a result, each potential vendor may be represented as being either above average or below average with respect to operational efficiency and market viability.

In certain embodiments, vendor classification logic 120 may additionally determine a spending score for each of the identified potential vendors. The determined spending score may be representative of the enterprise's previous spending with each of the identified potential vendors. For example, in addition to the above-discussed operational efficiency and market viability criteria, the user may specify one or more spending criteria. Vendor classification logic 120 may, for each potential vendor, access vendor data 116 corresponding to the identified spending criteria, and, based on the accessed vendor data 116, determine criteria-specific scores and a spending score for each potential vendor (in a manner substantially similar to that described above with regard to the operational efficiency and market viability scored). To the extent that no vendor data 116 corresponding to the specified spending criteria exists for a potential vendor (e.g., indicating that the enterprise has not previously done business with the potential vendor), vendor classification logic 120 may allocate a default spending score to the potential vendor (e.g., a value of one).

In embodiments in which vendor classification logic 120 determines a spending score for each of the identified potential vendors, vendor classification logic 120 may depict the spending scores on a z-axis of the generated graphical display. For example, each potential vendor may be represented on the graphical display as a circle positioned relative to the x-axis and y-axis as described above, with the size of the circle corresponding to the determined spending score.

As one particular example, a vendor classification logic 120 may determine an operation efficiency score, a market viability score, and a spending score as follows:
1. Operational Efficiency Score=Financial Strength+Employee Strength, where:
   a. Financial Strength=Average (Profitability Position criteria-specific score, Growth Position criteria-specific score, Liquidity Position criteria-specific score, Efficiency Position criteria-specific score), where:
      Profitability Position criteria-specific score=Average (GM*Weight, OM*Weight, NM*Weight), where:
         GM=Score (Gross profit margin) [i.e. Score 1 to the least value and n to the highest value (n is the total numbers of vendors)]
         OM=Score (Operating profit margin) [i.e. Score 1 to the least value and n to the highest value (n is the total numbers of vendors)]
         NM=Score (Net profit margin) [i.e. Score 1 to the least value and n to the highest value (n is the total numbers of vendors)]
         Weight=[High: 3, Moderate: 2, and Low: 1; (as assigned by user)]
      Growth Position criteria-specific score=Average (Annual Growth*Weight, 5 Year Growth*Weight, CapEx Growth*Weight), where:
         Annual Growth=Score (Sales 1 Year Growth Rate) [i.e. Score 1 to the least value and n to the highest value (n is the total numbers of vendors)]
         5 Year Growth=Score (Sales 5 Year Growth Rate) [i.e. Score 1 to the least value and n to the highest value (n is the total numbers of vendors)]
         CapEx Growth=Score (Capital Spending 5 Year Growth Rate) [i.e. Score 1 to the least value and n to the highest value (n is the total numbers of vendors)]
         Weight=[High: 3, Moderate: 2, and Low: 1; (as assigned by user)]
      Liquidity Position criteria-specific score=Average (CR*Weight, QR*Weight, DE*Weight), where:
         CR=Score (Current Ratio) [i.e. Score 1 to the least value and n to the highest value (n is the total numbers of vendors)]
         QR=Score (Quick Ratio) [i.e. Score 1 to the least value and n to the highest value (n is the total numbers of vendors)]
         DE=Score (Total Debt to Equity) [i.e. Score n to the least value and 1 to the highest value (n is the total numbers of vendors)]
         Weight=[High: 3, Moderate: 2, and Low: 1; (as assigned by user)]
      Efficiency Position criteria-specific score=Average (RT*Weight, IT* Weight, AT*Weight, RA*Weight), where:
         RT=Score (Receivable Turnover) [i.e. Score n to the least value and 1 to the highest value (n is the total numbers of vendors)]
         IT=Score (Inventory Turnover) [i.e. Score n to the least value and 1 to the highest value (n is the total numbers of vendors)]
         AT=Score (Assets Turnover) [i.e. Score 1 to the least value and n to the highest value (n is the total numbers of vendors)]
         RA=Score (Return on Assets) [i.e. Score 1 to the least value and n to the highest value (n is the total numbers of vendors)]
         Weight=[High: 3, Moderate: 2, and Low: 1; (as assigned by user)]
   b. Employee Strength=Average (RPE*Weight, NPE*Weight), where:
      RPE criteria-specific score=Score (Revenue per Employee) [i.e. Score 1 to the least value and n to the highest value (n is the total numbers of vendors)]
      NPE criteria-specific score=Score (Net Profit per Employee) [i.e. Score 1 to the least value and n to the highest value (n is the total numbers of vendors)]
      Weight=[High: 3, Moderate: 2, and Low: 1; (as assigned by user)]
2. Market Viability Score=Geographic Presence+Mergers & Acquisitions+Litigations, where:
   a. Geographic Presence=Average (GP*Weight, PA*Weight, PR*Weight), where:
      GP criteria-specific score=Score (Global Presence) [i.e. Score 1 to the least value and n to the highest value (n is the total numbers of vendors)]
      PA criteria-specific score=Score (Presence in Americas) [i.e. Score 1 to the least value and n to the highest value (n is the total numbers of vendors)]
      PR criteria-specific score=Score (Parent Region) [i.e. Score 1 to the least value and n to the highest value (n is the total numbers of vendors)]
      Weight=[High: 3, Moderate: 2, and Low: 1; (as assigned by user)]
   b. Mergers & Acquisitions=Average (NoA*Weight, TDV*Weight, NS* Weight, AS*Weight), where:
      NoA criteria-specific score=Score (Number of Acquisition) [i.e. Score 1 to the least value and n to the highest value (n is the total numbers of vendors)]
      TDV criteria-specific score=Score (Total Deal Value) [i.e. Score 1 to the least value and n to the highest value (n is the total numbers of vendors)]
      NS criteria-specific score=Score (New Service Added) [i.e. Score 1 to the least value and n to the highest value (n is the total numbers of vendors)]
      AS criteria-specific score=Score (Relation with Acquired Company) [i.e. Score 1 to the least value and n to the highest value (n is the total numbers of vendors)]
      Weight=[High: 3, Moderate: 2, and Low: 1; (as assigned by user)]
   c. Litigations=Average (PRL*Weight, CRL*Weight), where:
      PRL criteria-specific score=Score (Patent Related Litigations/Total Litigations) [i.e. Score n to the least value and 1 to the highest value (n is the total numbers of vendors)]
      CRL criteria-specific score=Score (General Contract Related Litigations/Total Litigations) [i.e. Score n to the least value and 1 to the highest value (n is the total numbers of vendors)]
      Weight=[High: 3, Moderate: 2, and Low: 1; (as assigned by user)]
3. Spending Score=Average (Spend Growth, 12 Month Spend, Spend v/s Revenue)+1, where:
   a. Spend Growth criteria specific score=Score [(Current Year Spend−Previous Year Spend)/Previous Year Spend] [i.e. Score 1 to the least value and n to the highest value (n is the total numbers of vendors)]
   b. 12 Month Spend criteria specific score=Score (Rolling 12 Month Spend) [i.e. Score 1 to the least value and n to the highest value (n is the total numbers of vendors)]
   c. Spend v/s Revenue criteria specific score=Score (Spend/Revenue) [i.e. Score 1 to the least value and n to the highest value (n is the total numbers of vendors)]

Although the example provided above includes particular operational efficiency, market viability, and spending criteria, the present disclosure contemplates any suitable specified criteria, according to particular needs.

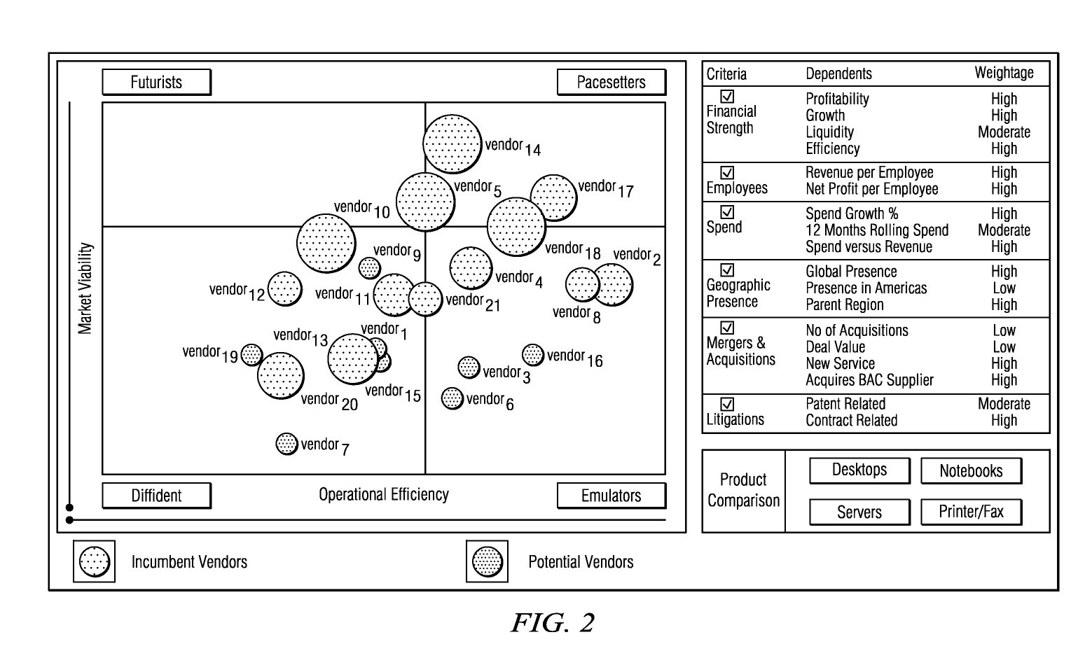

FIG. 2 illustrates an example graphical display constituting an industry level comparison of a number of potential computer hardware vendors, according to certain embodiments of the present disclosure. In the illustrated embodiment, the user has specified that each of the above-described criteria be taken into account (as indicated by the checked criteria boxes). Additionally, the user has specified a weighting for each of the specified criteria.

Returning to FIG. 1, vendor classification logic 120 may be further operable to generate a graphical display representing a product/service level comparison for each of the potential vendors identified in the user request. For example, a user of user system 102, having viewed an industry level comparison of a number of potential vendors, may additionally desire to view a product/service level comparison for each of the vendors. For example, having viewed an industry level comparison for a number of computer hardware providers, a user may desire to view a product level comparison for a particular piece of hardware in which the user is interested (e.g., desktop computers). Accordingly, the user of user system 102 may communicate an additional request for a product/service specific comparison to vendor classification logic 120. In certain embodiments, a list of products/services available for comparison may be provided as part of the graphical display representing an industry level comparison (e.g., the product comparison box depicted in FIG. 2), and the user may communicate the request for the product/service level comparison by selecting a particular one of the listed products/services.

In certain embodiment, the user request for product/service level comparison may specify a number of parameters governing the product/service level comparison. In certain embodiment, vendor classification logic 120 may be configured to account for a pre-determined set of equally-weighted parameters, and the user may be able to deselect certain of the pre-determined criteria and/or change the weighting allocated to certain criteria. Based on the specified parameters and weights, vendor classification logic 120 may (1) access vendor data 116 corresponding to the specified parameters, and (2) determine a market value score for each potential vendor, a features score for each potential vendor, and a presence score for each potential vendor. As a particular example, a user may specify parameters including Customer Review Experience, Reliability Study, Innovation, Availability of Options, Design, Technical Support, Technical Aspect, Customization, Global Presence, Global Market Share, Presence in BRIC, and US Market Share. Vendor classification logic 120 may access vendor data 116 corresponding to the specified parameters and determine a market value score for each vendor, a features score for each vendor, and a presence score for each potential vendor as follows:
1. Market Value Score=CRE+RS+AO, where:
   a. CRE=Score (Customer Review Experience)*Weight [i.e. Score 1 to the least value and n to the highest value (n is the total numbers of vendors)]
   b. RS=Score (Reliability Study)*Weight [i.e. Score 1 to the least value and n to the highest value (n is the total numbers of vendors)]
   c. AO=Score (Availability of Options)*Weight [i.e. Score 1 to the least value and n to the highest value (n is the total numbers of vendors)]
   d. Weight=1-10 [Highest is 10 and Lowest is 1 (as assigned by user)]
2. Features Score=INN+SS+TS, where
   a. INN=Score (Innovation)*Weight [i.e. Score 1 to the least value and n to the highest value (n is the total numbers of vendors)]
   b. SS=Score (Service Support)*Weight [i.e. Score 1 to the least value and n to the highest value (n is the total numbers of vendors)]
   c. AO=Score (Technical Aspect)*Weight [i.e. Score 1 to the least value and n to the highest value (n is the total numbers of vendors)]
   d. Weight=1 to 10 [Highest is 10 and Lowest is 1 (as assigned by user)]
3. Presence Score=GP+GMS+AMS+UMS, where:
   a. GP=Score (Global Presence)*Weight [i.e. Score 1 to the least value and n to the highest value (n is the total numbers of vendors)]
   b. GMS=Score (Global Market Share)*Weight [i.e. Score 1 to the least value and n to the highest value (n is the total numbers of vendors)]
   c. AMS=Score (APAC Market Share)*Weight [i.e. Score 1 to the least value and n to the highest value (n is the total numbers of vendors)]
   d. UMS=Score (US Market Share)*Weight [i.e. Score 1 to the least value and n to the highest value (n is the total numbers of vendors)]
   e. Weight=1 to 10 [Highest is 10 and Lowest is 1 (as assigned by user)]

Although the example provided above accounts for particular parameters in determining a market value score for each potential vendor, a features score for each potential vendor, and a presence score for each potential vendor, the present disclosure contemplates any suitable specified parameters being accounted for, according to particular needs.

Vendor classification logic 120, having determined market value scores, features scores, and presence scores for each potential vendor, may additionally be operable to generate a graphical display representing a product/service level comparison of all identified potential vendors. The graphical display may be delivered to the user via GUI 112. In certain embodiments, the graphical display may depict various combinations of plots of the potential vendors based on their determined market value scores, features scores, and a presence scores.

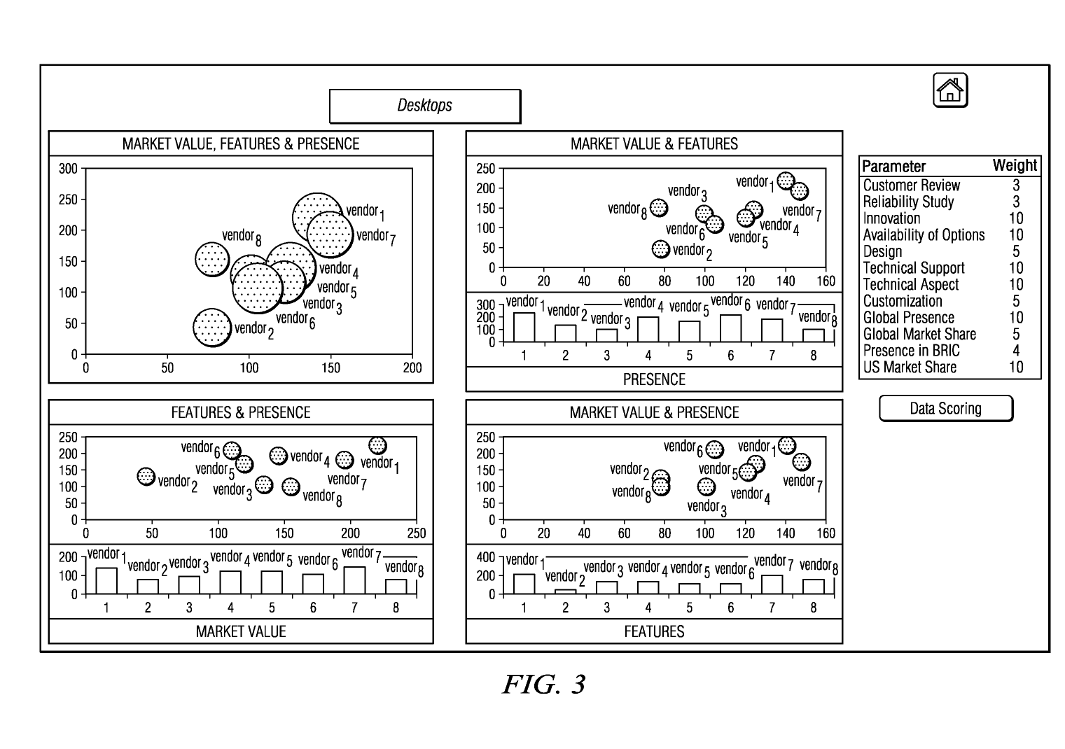

FIG. 3 illustrates an example graphical display constituting an product/service level comparison specific to desktop computers for a number of potential computer hardware vendors, according to certain embodiments of the present disclosure. In the illustrated embodiment, the user has specified that each of the above-described parameters be taken into account (as indicated by the parameters and weights). The illustrated graphical display includes 4 separate plots (starting at the upper right and moving clockwise): (1) market value (x-axis) vs. features (y-axis) vs. presence (x-axis), (2) market value (x-axis) vs. features (y-axis) (with presence represented on a separate plot), (3) features (x-axis) vs. presence (y-axis) (with market value represented on a separate plot), and (4) market value (x-axis) vs. presence (y-axis) (with features represented on a separate plot). Although FIG. 3 depicts a particular set of plots depicting market value scores, features scores, and presence scores for each potential vendor, the present disclosure contemplates any suitable combination of plots, according to particular needs.

Although a particular implementation of system 100 is illustrated and primarily described, the present disclosure contemplates any suitable implementation of system 100 according to particular needs. Although a particular number of components of system 100 have been illustrated and primarily described above, the present invention contemplates system 100 including any suitable number of such components. Furthermore, the various components of system 100 described above may be local or remote from one another. Additionally, the components of system 100 may be implemented in any suitable combination of hardware, firmware, and software.

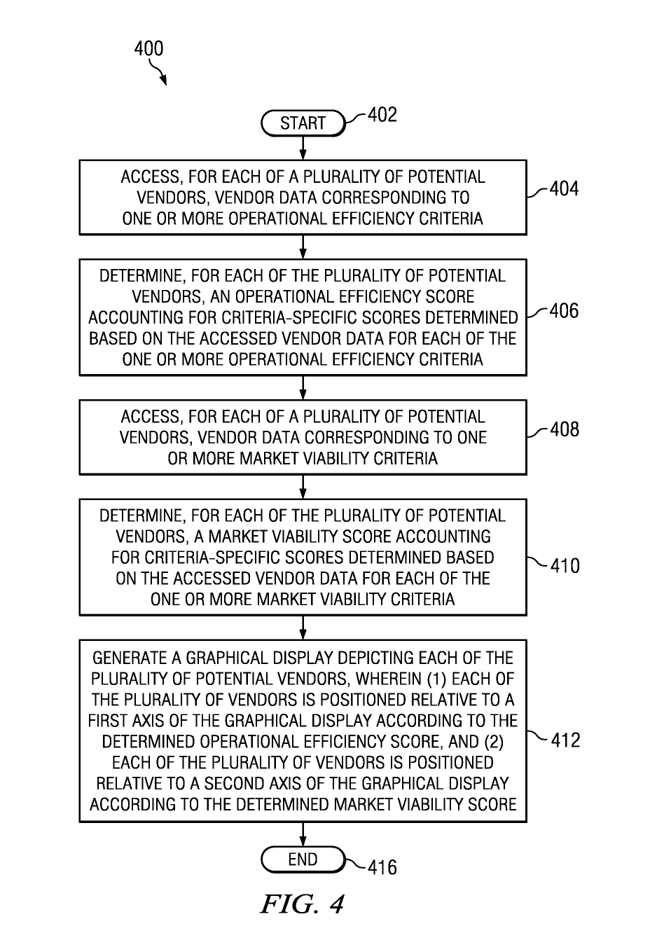

FIG. 4 illustrates an example method 400 for providing a comparative assessment of potential vendors for an enterprise, according to certain embodiments of the present disclosure. The method begins at step 402. At step 404, vendor classification system 104 accesses, for each of a plurality of potential vendors, vendor data 116 corresponding to one or more operational efficiency criteria. In certain embodiments, the operation efficiency criteria may be specified as part of a request received from a user of user system 102. At step, 406, vendor classification system 104 determines an operational efficiency score for each of the plurality of potential vendors. The operational efficiency score may be determined based on criteria-specific scores determined for each of the operational efficiency criteria, the criteria specific scores being determined based on the accessed vendor data.

At step 408, vendor classification system 104 accesses, for each of a plurality of potential vendors, vendor data 112 corresponding to one or more market viability criteria. In certain embodiments, the market viability criteria may be specified as part of a request received from a user of user system 102. At step, 410, vendor classification system 104 determines an market viability score for each of the plurality of potential vendors. The market viability score may be determined based on criteria-specific scores determined for each of the market viability criteria, the criteria specific scores being determined based on the accessed vendor data.

At step 412, vendor classification system 104 generates a graphical display depicting each of the plurality of potential vendors. On the graphical display, each of the plurality of potential vendors is positioned relative to a first axis according to the determined operational efficiency score and a second axis according to the determined market viability score. The generated graphical display may be presented to a user of user system 102 via GUI 112.

Although the steps of method 400 have been described as being performed in a particular order, the present disclosure contemplates that the steps of method 400 may be performed in any suitable order, according to particular needs.

Although the present disclosure has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

1. A method for providing a comparative assessment of potential vendors for an enterprise, comprising:
accessing, for each of a plurality of potential vendors, vendor data corresponding to operational efficiency criteria, the operational efficiency criteria comprising criteria corresponding to financial strength of each potential vendor and criteria corresponding to a net profit per employee of each potential vendor;
determining, using one or more processing modules, an operational efficiency score for each of the plurality of potential vendors, the operational efficiency score for each of the plurality of potential vendors accounting for criteria-specific scores determined based on the accessed vendor data for the criteria corresponding to the financial strength of each potential vendor and the criteria corresponding to the net profit per employee of each potential vendor;
accessing, for each of the plurality of potential vendors, vendor data corresponding to market viability criteria, the market viability criteria comprising criteria corresponding to the geographic presence of each potential vendor, criteria corresponding to mergers and acquisitions involving each potential vendor, and criteria corresponding to litigations involving each potential vendor;
determining, using the one or more processing modules, a market viability score for each of the plurality of potential vendors, the market viability score for each of the plurality of potential vendors accounting for criteria-specific scores determined based on the accessed vendor data for the criteria corresponding to geographic presence of each potential vendor, the criteria corresponding to mergers and acquisitions involving each potential vendor, and the criteria corresponding to litigations involving each potential vendor;
accessing, for each of the plurality of potential vendors, vendor data corresponding to spending criteria, the spending criteria comprising criteria corresponding to a percentage of each potential vendor revenue derived from enterprise spending and criteria corresponding to growth percentage of enterprise spending with each potential vendor;
determining a spending score for each of a plurality of potential vendors, the spending score for each of a plurality of potential vendors accounting for criteria-specific scores determined based on the accessed vendor data for the criteria corresponding to a percentage of each potential vendor revenue derived from enterprise spending and criteria corresponding to growth percentage of enterprise spending with each potential vendor; and
generating, using the one or more processing modules, a graphical display depicting each of the plurality of potential vendors, wherein:
each of the plurality of vendors is positioned relative to a first axis of the graphical display according to the determined operational efficiency score;
each of the plurality of vendors is positioned relative to a second axis of the graphical display according to the determined market viability score; and
each of the plurality of potential vendors is positioned relative to a third axis of the graphical display according to the determined spending score.

2. The method of claim 1, wherein the one or more operational efficiency criteria and the market viability criteria are each specified in a user request.

3. The method of claim 1, wherein the criteria-specific scores for each of the operational efficiency criteria and the market viability criteria account for a weight allocated to the criteria.

4. (canceled)

5. (canceled)

6-7. (canceled)

8. A system for providing a comparative assessment of potential vendors for an enterprise, comprising:
one or more memory modules storing vendor data for each of a plurality of potential vendors; and
one or more processing modules operable to:
access, for each of the plurality of potential vendors, vendor data corresponding to operational efficiency criteria, the operational efficiency criteria comprising criteria corresponding to financial strength of each potential vendor and criteria corresponding to a net profit per employee of each potential vendor;
determine an operational efficiency score for each of the plurality of potential vendors, the operational efficiency score for each of the plurality of potential vendors accounting for criteria-specific scores determined based on the accessed vendor data for the criteria corresponding to the financial strength of each potential vendor and the criteria corresponding to the net profit per employee of each potential vendor;
access, for each of the plurality of potential vendors, vendor data corresponding to market viability criteria, the market viability criteria comprising criteria corresponding to geographic presence of each potential vendor, criteria corresponding to mergers and acquisitions involving each potential vendor, and criteria corresponding to litigations involving each potential vendor;
determine a market viability score for each of the plurality of potential vendors, the market viability score for each of the plurality of potential vendors accounting for criteria-specific scores determined based on the accessed vendor data for the criteria corresponding to the geographic presence of each potential vendor, the criteria corresponding to mergers and acquisitions involving each potential vendor, and the criteria corresponding to litigations involving each potential vendor;
access, for each of the plurality of potential vendors, vendor data corresponding to spending criteria, the spending criteria comprising criteria corresponding to a percentage of each potential vendor revenue derived from enterprise spending and criteria corresponding to growth percentage of enterprise spending with each potential vendor;
determine a spending score for each of a plurality of potential vendors, the spending score for each of a plurality of potential vendors accounting for criteria-specific scores determined based on the accessed vendor data for the criteria corresponding to a percentage of each potential vendor revenue derived from enterprise spending and criteria corresponding to growth percentage of enterprise spending with each potential vendor; and
generate a graphical display depicting each of the plurality of potential vendors, wherein:
each of the plurality of vendors is positioned relative to a first axis of the graphical display according to the determined operational efficiency score;
each of the plurality of vendors is positioned relative to a second axis of the graphical display according to the determined market viability score; and
each of the plurality of potential vendors is positioned relative to a third axis of the graphical display according to the determined spending score.

9. The system of claim 8, wherein the one or more operational efficiency criteria and the market viability criteria are each specified in a user request.

10. The system of claim 8, wherein the criteria-specific scores for each of the operational efficiency criteria and the market viability criteria account for a weight allocated to the criteria.

11. (canceled)

12. (canceled)

13-14. (canceled)

15. A non-transitory computer readable medium encoded with logic for providing a comparative assessment of potential vendors for an enterprise, the logic operable when executed to perform operations comprising:
accessing, for each of a plurality of potential vendors, vendor data corresponding to operational efficiency criteria, the operational efficiency criteria comprising criteria corresponding to financial strength of each potential vendor and criteria corresponding to a net profit per employee of each potential vendor;
determining an operational efficiency score for each of the plurality of potential vendors, the operational efficiency score for each of the plurality of potential vendors accounting for criteria-specific scores determined based on the accessed vendor data for the criteria corresponding to the financial strength of each potential vendor and the criteria corresponding to the net profit per employee of each potential vendor;
accessing, for each of the plurality of potential vendors, vendor data corresponding to market viability criteria, the market viability criteria comprising criteria corresponding to geographic presence of each potential vendor, criteria corresponding to mergers and acquisitions involving each potential vendor, and criteria corresponding to litigations involving each potential vendor;
determining a market viability score for each of the plurality of potential vendors, the market viability score for each of the plurality of potential vendors accounting for criteria-specific scores determined based on the accessed vendor data for the criteria corresponding to the geographic presence of each potential vendor, the criteria corresponding to mergers and acquisitions involving each potential vendor, and the criteria corresponding to litigations involving each potential vendor;
accessing, for each of the plurality of potential vendors, vendor data corresponding to spending criteria, the spending criteria comprising criteria corresponding to a percentage of each potential vendor revenue derived from enterprise spending and criteria corresponding to growth percentage of enterprise spending with each potential vendor;
determining a spending score for each of a plurality of potential vendors, the spending score for each of a plurality of potential vendors accounting for criteria-specific scores determined based on the accessed vendor data for the criteria corresponding to a percentage of each potential vendor revenue derived from enterprise spending and criteria corresponding to growth percentage of enterprise spending with each potential vendor; and
generating, using the one or more processing modules, a graphical display depicting each of the plurality of potential vendors, wherein:
each of the plurality of vendors is positioned relative to a first axis of the graphical display according to the determined operational efficiency score;
each of the plurality of vendors is positioned relative to a second axis of the graphical display according to the determined market viability score; and
each of the plurality of potential vendors is positioned relative to a third axis of the graphical display according to the determined spending score.

16. The computer readable medium of claim 15, wherein the one or more operational efficiency criteria and the market viability criteria are each specified in a user request.

17. The computer readable medium of claim 15, wherein the criteria-specific scores for each of the operational efficiency criteria and the market viability criteria account for a weight allocated to the criteria.

18. (canceled)

19. (canceled)

20-21. (canceled)
